(19) United States
(12) Patent Application Publication
(10) Pub. No.: US 2009/0110373 A1
(43) Pub. Date: Apr. 30, 2009

(54) Information Playback Apparatus

(75) Inventors: Kazunori Aoyagi, Fussa-shi (JP); Shigemi Nakasato, Inagi-shi (JP); Hideaki Haruyama, Fujisawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/244,646

(22) Filed: Oct. 2, 2008

(30) Foreign Application Priority Data
Oct. 26, 2007 (JP) 2007-279266

(51) Int. Cl. H04N 7/00

(52) U.S. Cl. 386/124; 386/E05.001

(57) ABSTRACT

According to one embodiment, an information playback apparatus according to one embodiment of the invention includes an acquisition module configured to acquire content data, an analysis module configured to analyze the content data to generate viewing and listening environment control information based on an analysis result, a viewing and listening control module configured to control a viewing and listening environment based on the viewing and listening environment control information, and a playback control module configured to control playback of the content data under the viewing and listening environment.

### CROSS-REFERENCE TO RELATED APPLICATIONS

This application is based upon and claims the benefit of priority from Japanese Patent Application No. 2007-279266, filed Oct. 26, 2007, the entire contents of which are incorporated herein by reference.

### BACKGROUND

1. Field

One embodiment of the invention relates to an information playback technique which plays back content provided by broadcasting signals, and content stored in information storage media such as a DVD and the like.

2. Description of the Related Art

In recent years, technical developments for providing comfortable viewing and listening environments by video playback apparatuses have been extensively made. For example, Jpn. Pat. Appln. KOKAI Publication No. 2006-267789 proposes a technique that allows a viewer to comfortably appreciate content without any unpleasant gaze upon viewing the content displayed on a display unit of a display (see patent reference 1). More specifically, the display comprises a display unit, a housing to which the display unit is attached, an optical sensor which is arranged on the surface of the housing different from the display surface of the display unit, and a control circuit which controls the luminance of the display unit based on a signal from the optical sensor.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a schematic block diagram showing the arrangement of an information playback apparatus according to an embodiment of the present invention;

FIG. 2 is a block diagram showing an illumination apparatus controlled by the information playback apparatus via a wireless communication according to the embodiment;

FIG. 3 is a block diagram showing an external loudspeaker controlled by the information playback apparatus via a wireless communication according to the embodiment; and

FIG. 4 is a flowchart showing an example of priority control based on metadata according to the embodiment.

### DETAILED DESCRIPTION

Various embodiments according to the invention will be described hereinafter with reference to the accompanying drawings. In general, an information playback apparatus according to one embodiment of the invention comprises an acquisition module configured to acquire content data, an analysis module configured to analyze the content data to generate viewing and listening environment control information based on an analysis result, a viewing and listening control module configured to control a viewing and listening environment based on the viewing and listening environment control information, and a playback control module configured to control playback of the content data under the viewing and listening environment.

An embodiment of the invention will be described hereinafter with reference to the accompanying drawings.

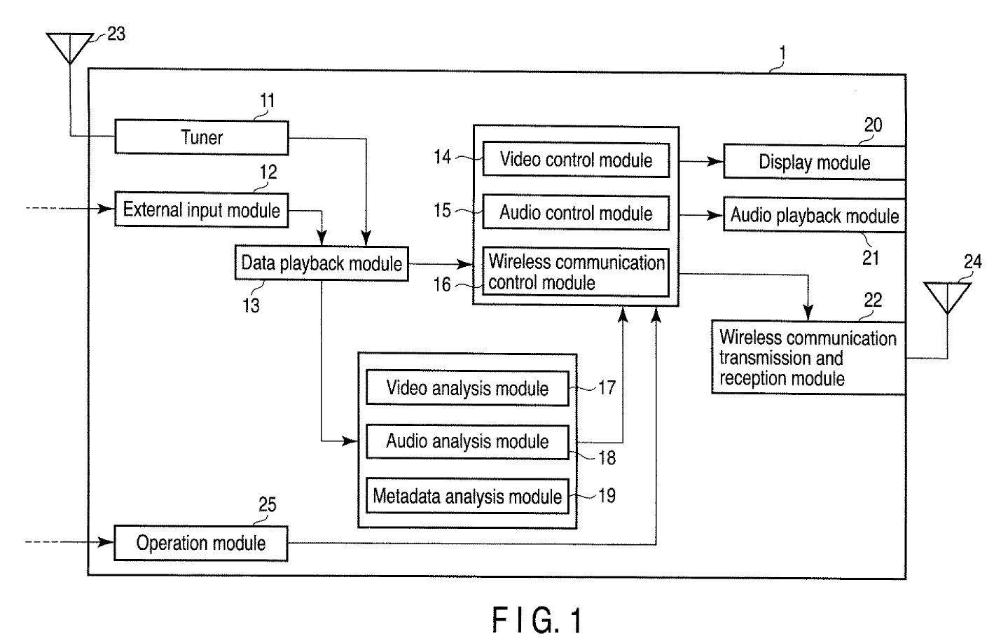

FIG. 1 is a schematic block diagram showing the arrangement of an information playback apparatus (an information playback system) according to an embodiment of the invention. As shown in FIG. 1, an information playback apparatus 1 comprises a tuner 11, external input module 12, data playback module 13, video control module 14, audio control module 15, wireless communication control module 16, video analysis module 17, audio analysis module 18, metadata analysis module 19, display module 20, audio playback module 21, radio communication transmission and reception module 22, broadcasting reception antenna 23, wireless communication antenna 24, and operation module 25.

The tuner 11 selects a signal of a channel designated via the operation module 25 from a reception signal received via the broadcasting reception antenna 23, and supplies the selected channel signal to the data playback module 13. The data playback module 13 decodes the supplied channel signal to acquire content data. The data playback module 13 supplies video data included in the content data to the video control module 14 and video analysis module 17, audio data included in the content data to the audio control module 15 and audio analysis module 18, and metadata included in the content data to the metadata analysis module 19.

The external input module 12 is connected to a video playback apparatus such as a DVD player or the like. The external input module 12 receives a signal from the video playback apparatus, and supplies the received signal to the data playback module 13. The data playback module 13 decodes the supplied signal to acquire content data. The data playback module 13 supplies video data included in the content data to the video control module 14 and video analysis module 17, audio data included in the content data to the audio control module 15 and audio analysis module 18, and metadata included in the content data to the metadata analysis module 19.

The video control module 14 adjusts the luminance, lightness, and saturation of video data based on viewing and listening environment control information (to be described later), and outputs the adjusted video data to the display module 20 such as a liquid crystal display or the like. The audio control module 15 adjusts the tone volume and tone quality of audio data based on viewing and listening environment control information (to be described later), and outputs the adjusted audio data to the audio playback module 21 such as a loudspeaker or the like. The wireless communication control module 16 transmits viewing and listening environment control information (to be described later) to the wireless communication transmission and reception module 22. The wireless communication transmission and reception module 22 transmits viewing and listening environment control information to viewing and listening environment apparatuses via the wireless communication antenna 24. For example, the wireless communication transmission and reception module 22 and wireless communication antenna 24 are compatible with Bluetooth®, and transmit viewing and listening environment control information to Bluetooth-compatible viewing and listening environment apparatuses.

The video analysis module 17 analyzes video data, generates viewing and listening environment control information based on the analysis result of the video data, and transmits the generated viewing and listening environment control information to the video control module 14, audio control module 15, and wireless communication control module 16. For example, the video analysis module 17 detects guide text in video data, analyzes the detected guide text, and generates viewing and listening environment control information required to control the current environment to a viewing and listening environment required by the content provider.

The audio analysis module 18 analyzes audio data, generates a viewing and listening environment control signal based on the analysis result of the audio data, and transmits the generated viewing and listening environment control signal to the video control module 14, audio control module 15, and wireless communication control module 16. For example, the audio analysis module 18 detects a guide audio in the audio data, analyzes the detected guide audio, and generates a viewing and listening environment control signal required to control the current environment to a viewing and listening environment required by the content provider.

The metadata analysis module 19 analyzes metadata, generates viewing and listening environment control information based on the analysis result of the metadata, and transmits the generated viewing and listening environment control information to the video control module 14, audio control module 15, and wireless communication control module 16. For example, the metadata analysis module 19 generates viewing and listening environment control information required to control the current environment to a viewing and listening environment required by the content provider based on a control code in the metadata.

Video and audio playback control by the video analysis module 17 will be described below. Video data acquired by the data playback module 13 is sent to the video analysis module 17. The video analysis module 17 analyzes the video data to detect viewing and listening environment Information. For example, the video analysis module 17 detects guidance information included in the video data, and analyzes the content included in the guidance information. Upon detection of guidance information corresponding to viewing and listening environment information, the video analysis module 17 generates viewing and listening environment control information according to the viewing and listening environment information included in the guidance information, and transmits the viewing and listening environment control information to the video control module 14, audio control module 15, and wireless communication control module 16.

For example, when the video analysis module 17 detects content “lower brightness of screen upon viewing and listening” from the guidance information, it generates viewing and listening environment control information that instructs to lower the luminance or lightness of the screen, and transmits that information to the video control module 14. The video control module 14 lowers the luminance of the video data based on the viewing and listening environment control information, and controls the video display module 20 to play back the video data.

When the video analysis module 17 detects content “lower tone volume” from the guidance information, it generates viewing and listening environment control information that instructs to lower the tone volume, and transmits that information to the audio control module 15. The audio control module 15 lowers the tone volume of audio data based on the viewing and listening environment control information, and controls the audio playback module 21 to play back the audio data.

When the video analysis module 17 detects content “light up room well upon viewing and listening” from the guidance information, it generates viewing and listening environment control information that instructs to increase illumination, and transmits that information to the wireless communication control module 16. The wireless communication control module 16 transmits the viewing and listening environment control information that instructs to increase illumination via the wireless communication transmission and reception module 22 and wireless communication antenna 24.

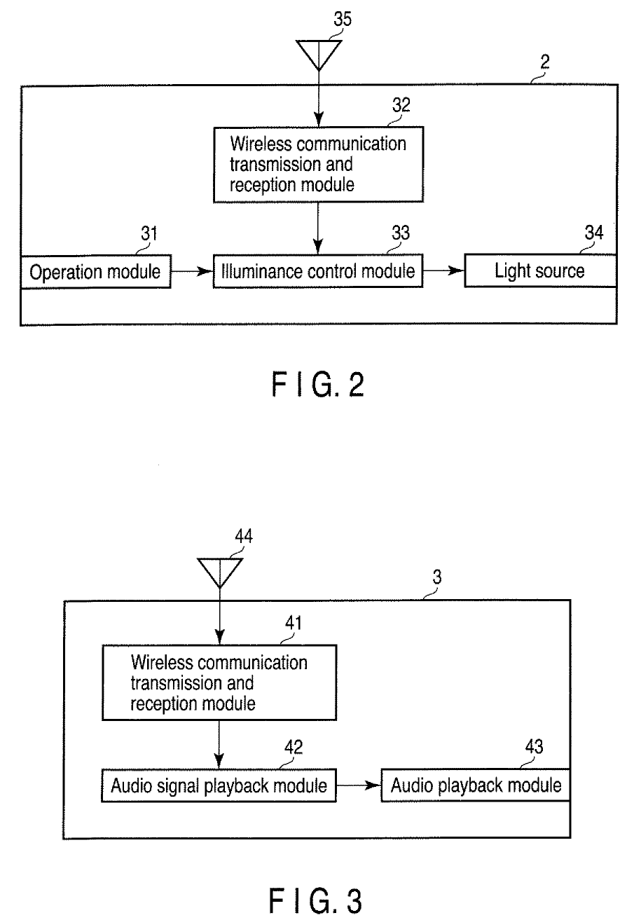

FIG. 2 shows an example of an illumination apparatus 2 controlled by the information playback apparatus 1 via a wireless communication. The illumination apparatus 2 comprises an operation module 31, wireless communication transmission and reception module 32, illuminance control module 33, light source 34, and wireless communication antenna 35.

The operation module 31 accepts a change instruction to change the brightness of illumination from the user, and transmits the accepted change instruction to the illuminance control module 33. The illuminance control module 33 controls the illuminance of the light source 34 based on the change instruction. The wireless communication antenna 35 receives the viewing and listening environment control information transmitted from the wireless communication antenna 24 of the information playback apparatus 1, and transmits the received information to the wireless communication transmission and reception module 32. The wireless communication transmission and reception module 32 transmits the viewing and listening environment control information to the illuminance control module 33, which controls the illuminance of the light source 34 based on the viewing and listening environment control information.

For example, when the video analysis module 17 of the information playback apparatus 1 detects content “light up room well upon viewing and listening” from guidance information, the wireless communication control module 16 requests the illumination apparatus 2 to establish wireless communication connection, so as to increase the illumination of a viewing and listening room. That is, the wireless communication control module 16 transmits a connection request signal to the illumination apparatus 2 via the wireless communication transmission and reception module 22 and wireless communication antenna 24. Upon reception of the connection request signal via the wireless communication antenna 35 and wireless communication transmission and reception module 32, the illumination apparatus 2 establishes wireless communication connection with the information playback apparatus 1. Furthermore, the viewing and listening environment control information which instructs to increase the illuminance of illumination of the room and is modulated by the wireless communication transmission and reception module 22 of the information playback apparatus 1 is transmitted via the wireless communication antenna 24. The wireless communication antenna 35 and wireless communication transmission and reception module 32 of the illumination apparatus 2 receive the viewing and listening environment control information from the information playback apparatus 1, and the illuminance control module 33 controls the illuminance of the light source 34 based on the received viewing and listening environment control information. That is, the illuminance control module 33 increases the illuminance of the light source 34 based on the received viewing and listening environment control information.

With the aforementioned sequence, the video and audio playback condition and surrounding viewing and listening environment can be controlled based on video data included in content to be played back by the information playback apparatus 1.

Video and audio playback control by the audio analysis module 18 will be described below. Audio data acquired by the data playback module 13 is sent to the audio analysis module 18. The audio analysis module 18 analyzes the audio data to detect viewing and listening environment information. For example, the audio analysis module 18 analyzes the content of announcements included in the audio data, and detects an announcement corresponding to the viewing and listening environment information. The audio analysis module 18 transmits viewing and listening environment control information according to the content of the detected announcement to the video control module 14, audio control module 15, and wireless communication control module 16.

For example, when the audio analysis module 18 detects an announcement with content “lower brightness of screen upon viewing and listening” from the audio data, it generates viewing and listening environment control information that instructs to lower the luminance or lightness of the screen, and transmits that information to the video control module 14. The video control module 14 lowers the luminance of video data based on the viewing and listening environment control information, and controls the video display module 20 to play back the video data.

When the audio analysis module 18 detects an announcement with content “lower tone volume” from the audio data, it transmits viewing and listening environment control Information that instructs to lower the tone volume to the audio control module 15. The audio control module 15 lowers the tone volume of audio data based on the viewing and listening environment control information, and controls the audio playback module 21 to play back the audio data.

When the audio analysis module 18 detects an announcement with content “light up room well upon viewing and listening” from the audio data, the wireless communication control module 16 requests the illumination apparatus 2 to establish wireless communication connection, so as to increase illumination of a viewing and listening room. That is, the wireless communication control module 16 transmits a connection request signal to the illumination apparatus 2 via the wireless communication transmission and reception module 22 and wireless communication antenna 24. Upon reception of the connection request signal via the wireless communication antenna 35 and wireless communication transmission and reception module 32, the illumination apparatus 2 establishes wireless communication connection with the information playback apparatus 1. Furthermore, the viewing and listening environment control information which instructs to increase the iluminance of illumination of the room and is modulated by the wireless communication transmission and reception module 22 of the information playback apparatus 1 is transmitted via the wireless communication antenna 24. The wireless communication antenna 35 and wireless communication transmission and reception module 32 of the illumination apparatus 2 receive the viewing and listening environment control information from the information playback apparatus 1, and the illuminance control module 33 controls the illuminance of the light source 34 based on the received viewing and listening environment control information. That is, the illuminance control module 33 increases the illuminance of the light source 34 based on the received viewing and listening environment control information.

With the aforementioned sequence, the video and audio playback condition and surrounding viewing and listening environment can be controlled based on audio data included in content to be played back by the information playback apparatus 1.

Video and audio playback control by the metadata analysis module 19 will be described below. Content data acquired by the data playback module 13 often includes metadata associated with content in addition to video data and audio data. This metadata includes information of the content, genre, audio data format, and the like of content. The metadata analysis module 19 analyzes the metadata to detect viewing and listening environment information. For example, when the content data supports 5.1-channel audio data, and the information playback apparatus 1 does not comprise any playback environment of 5.1-channel audio data, the information playback apparatus 1 alone cannot play back 5.1-channel audio. Hence, using external loudspeakers 3 (for example, six external loudspeakers 3) which comprises a wireless communication function, as shown in FIG. 3, 5.1-channel audio is played back. That is, the information playback apparatus 1 controls the external loudspeakers 3 (for example, six external loudspeakers 3) to play back 5.1-channel audio. The external loudspeaker 3 shown in FIG. 3 comprises a wireless communication transmission and reception module 41, audio signal playback module 42, audio playback module 43, and wireless communication antenna 44.

When the metadata analysis module 19 detects the 5.1-channel audio data format, the wireless communication control module 16 requests each external loudspeaker 3 to establish wireless communication connection, so as to play back 5.1-channel audio data. That is, the wireless communication control module 16 transmits a connection request signal to the external loudspeaker 3 via the wireless communication transmission and reception module 22 and wireless communication antenna 24. Upon reception of the connection request signal via the wireless communication antenna 44 and wireless communication transmission and reception module 41, the external loudspeaker 3 establishes wireless communication connection with the information playback apparatus 1. Furthermore, audio data which is modulated by the wireless communication transmission and reception module 22 of the information playback apparatus 1 is transmitted via the wireless communication antenna 24. The wireless communication antenna 44 and wireless communication transmission and reception module 41 of the external loudspeaker 3 receive the audio data from the information playback apparatus 1. The audio signal playback module 42 decodes the received audio data, and the audio playback module 43 plays back the decoded audio data. This processing is executed for a required number of external loudspeakers 3 (six loudspeakers in the case of 5.1 channels). In this way, audio data can be played back using 5.1 channels.

Alternatively, when the metadata analysis module 19 detects a control code that instructs to lower the brightness of the screen upon viewing and listening from the metadata, or it determines based on the content or genre of content in the metadata that it is proper to lower the brightness of the screen upon viewing and listening, it transmits viewing and listening environment control information that instructs to lower the luminance or lightness of the screen to the video control module 14. The video control module 14 lowers the luminance of video data based on the viewing and listening environment control information, and controls the video display module 20 to play back the video data.

When the metadata analysis module 19 detects a control code that instructs to lower the tone volume from the metadata, or it determines based on the content or genre of content in the metadata that it is proper to lower the tone volume upon viewing and listening, it transmits viewing and listening environment control information that instructs to lower the tone volume to the audio control module 15. The audio control module 15 lowers the tone volume of audio data based on the viewing and listening environment control information, and controls the audio playback module 21 to play back the audio data.

When the metadata analysis module 19 detects a control code that instructs to light up a room well upon viewing and listening from the metadata or it determines based on the content or genre of content in the metadata that it is proper to light up the room well upon viewing and listening, the wireless communication control module 16 requests the illumination apparatus 2 to establish wireless communication connection, so as to increase illumination of the room during viewing and listening. That is, the wireless communication control module 16 transmits a connection request signal to the illumination apparatus 2 via the wireless communication transmission and reception module 22 and wireless communication antenna 24 Upon reception of the connection request signal via the wireless communication antenna 35 and wireless communication transmission and reception module 32, the illumination apparatus 2 establishes wireless communication connection with the information playback apparatus 1. Furthermore, viewing and listening environment control information which instructs to increase the illuminance of illumination of a room and is modulated by the wireless communication transmission and reception module 22 of the information playback apparatus 1 is transmitted via the wireless communication antenna 24. The wireless communication antenna 35 and wireless communication transmission and reception module 32 of the illumination apparatus 2 receive the viewing and listening environment control information from the information playback apparatus 1, and the illuminance control module 33 controls the illuminance of the light source 34 based on the received viewing and listening environment control information. That is, the illuminance control module 33 increases the illuminance of the light source 34 based on the received viewing and listening environment control information.

With the aforementioned sequence, the video and audio playback condition and surrounding viewing and listening environment can be controlled based on metadata included in content to be played back by the information playback apparatus 1.

According to this embodiment, the luminance of a video to be played back by the display module 20, and the tone volume of an audio to be played back by the audio playback module 21 can be controlled based on information such as the video data, audio data, metadata, and the like included in content to be played back by the information playback apparatus, and the illuminance f the external illumination apparatus 2 and the audio playback method by the external loudspeakers 3 can also be controlled, thus providing an optimal viewing and listening environment according to the content

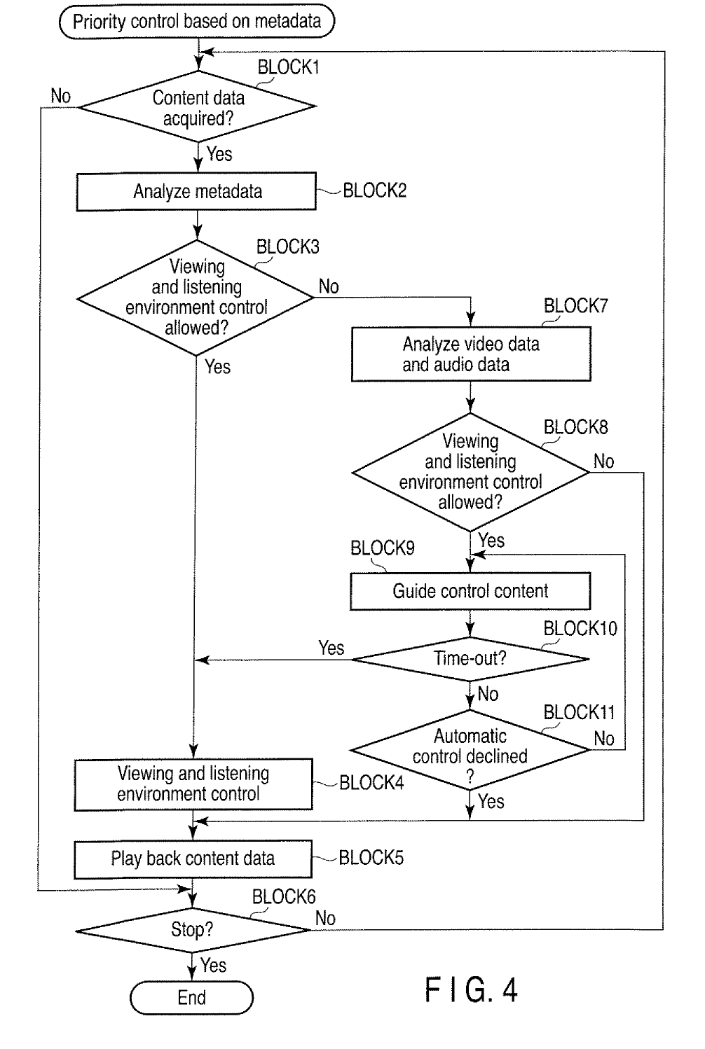

Priority control based on metadata will be described below with reference to the flowchart shown in FIG. 4.

If the information playback apparatus 1 acquires content data (YES in BLOCK1), the metadata analysis module 19 analyzes metadata included in the content data (BLOCK2). If the metadata analysis module 19 detects the aforementioned control codes and the like by analyzing the metadata, and determines that viewing and listening environment control can be made (YES in BLOCK3), it generates viewing and listening environment control information based on the analysis result of the metadata, and transmits the viewing and listening environment control information to the video control module 14, audio control module 15, and wireless communication control module 16. The video control module 14, audio control module 15, and wireless communication control module 16 control the display module 20, audio playback module 21, illumination apparatus 2, external loudspeakers 3, and the like based on the viewing and listening environment control information, thus adjusting the current environment to an appropriate viewing and listening environment (BLOCK4). The data playback module 13 plays back the content data under the adjusted viewing and listening environment (BLOCK5). The processing continues until the information playback apparatus 1 is stopped (BLOCK6).

On the other hand, if the metadata analysis module 19 determines based on the analysis result of the metadata that viewing and listening environment control cannot be done (NO in BLOCK3) or if the content data does not include any metadata (NO in BLOCK3), the video analysis module 17 and audio analysis module 18 detect viewing and listening environment information, and analyze the detected viewing and listening environment information (BLOCK7).

For example, if the video analysis module 17 detects content “lower brightness of screen upon viewing and listening” from a guidance information (YES in BLOCK8), the video control module 14 displays “a guidance indicating that the brightness of the screen is automatically lowered, and an item used to decline automatic control” on the display module 20 (BLOCK9). If the video analysis module 17 detects content “lower tone volume” from guidance information (YES in BLOCK8), the video control module 14 displays “a guidance indicating that the tone volume is automatically lowered, and an item used to decline automatic control” on the display module 20 (BLOCK9). If the video analysis module 17 detects content “light up room well upon viewing and listening” from guidance information (YES in BLOCKS), the video control module 14 displays “a guidance indicating that illumination of a room is automatically increased, and an item used to decline automatic control” on the display module 20 (BLOCK9). If the audio analysis module 18 detects an announcement with content “lower brightness of screen upon viewing and listening” from audio data (YES in BLOCK8), the video control module 14 displays “a guidance indicating that the brightness of the screen is automatically lowered, and an item used to decline automatic control” on the display module 20 (BLOCK9). If the audio analysis module 18 detects an announcement with content “lower tone volume” from audio data (YES in BLOCKS), the video control module 14 displays “a guidance indicating that the tone volume is automatically lowered, and an item used to decline automatic control” on the display module 20 (BLOCK9). If the audio analysis module 18 detects an announcement with content “light up room well upon viewing and listening” from audio data (YES in BLOCKS), the video control module 14 displays “a guidance indicating that illumination of a room is automatically lit up well, and an item used to decline automatic control” on the display module 20 (BLOCK9).

If the user instructs to select “the item used to decline automatic control” (YES in BLOCK11) via the operation module 25 of the information playback apparatus 1 within a predetermined period of time (NO in BLOCK10), the data playback module 13 plays back the content data without automatically controlling a viewing and listening environment (BLOCK5).

If the predetermined period of time has elapsed (YES in BLOCK10) without selecting “the item used to decline automatic control”, the video control module 14, audio control module 15, and wireless communication control module 16 control the display module 20, audio playback module 21, illumination apparatus 2, external loudspeakers 3, and the like based on the generated viewing and listening environment control information, thereby adjusting the current environment to an appropriate viewing and listening environment (BLOCK4). The data playback module 13 plays back the content data in the adjusted viewing and listening environment (BLOCK5). The processing continues until the information playback apparatus 1 is stopped (BLOCK6).

As described above, under the priority control based on the metadata, for example, even when the reliabilities of video analysis and audio analysis by the video analysis module 17 and audio analysis module 18 are low, viewing and listening environment control with a relatively high reliability can be attained using the metadata analysis result of the metadata analysis module 19. When the video analysis module 17 and audio analysis module 18 are configured using relatively inexpensive video and audio analysis circuits (to attain a cost reduction of the information playback apparatus 1), a high reliability to some extent can be maintained, thus effectively achieving both the cost reduction and high reliability.

Control of external apparatuses has been described taking the illumination apparatus 2 and external loudspeaker 3 as an example. However, the present invention is not limited to such specific apparatuses. For example, an external apparatus as a noise source upon playing back content by the information playback apparatus 1 is controlled (to, e.g., stop the external apparatus as a noise source), and generation of noise upon playing back content can be suppressed.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modification as would fall within the scope and spirit of the inventions.

What is claimed is:

1. An information playback apparatus comprising:
an acquisition module configured to acquire content data;
an analysis module configured to analyze the content data to generate viewing and listening environment control information based on an analysis result;
a viewing and listening control module configured to control a viewing and listening environment based on the viewing and listening environment control information; and
a playback control module configured to control playback of the content data under the viewing and listening environment.

2. The apparatus according to claim 1 wherein the analysis module analyzes video data included in the content data to generate the viewing and listening environment control information based on the analysis result, and
the viewing and listening control module controls at least one of a display output and audio output of the content based on the viewing and listening environment control information.

3. The apparatus according to claim 1, wherein the analysis module analyzes video data included in the content data to generate the viewing and listening environment control information based on the analysis result, and
the viewing and listening control module controls a viewing and listening environment apparatus based on the viewing and listening environment control information via a wireless communication.

4. The apparatus according to claim 1, wherein the analysis module analyzes audio data included in the content data to generate the viewing and listening environment control information based on the analysis result, and
the viewing and listening control module controls at least one of a display output and audio output of the content based on the viewing and listening environment control information.

5. The apparatus according to claim 1, wherein the analysis module analyzes audio data included in the content data to generate the viewing and listening environment control information based on the analysis result, and
the viewing and listening control module controls a viewing and listening environment apparatus based on the viewing and listening environment control information via a wireless communication.

6. The apparatus according to claim 1, wherein the analysis module analyzes information associated with content in metadata included in the content data to generate the viewing and listening environment control information based on the analysis result, and
the viewing and listening control module controls at least one of a display output and audio output of the content based on the viewing and listening environment control information.

7. The apparatus according to claim 1, wherein the analysis module analyzes information associated with content in metadata included in the content data to generate the viewing and listening environment control information based on the analysis result, and
the viewing and listening control module controls a viewing and listening environment apparatus based on the viewing and listening environment control information via a wireless communication.

8. The apparatus according to claim 1, wherein the analysis module generates viewing and listening environment control information by at least one of text analysis in video data included in the content data, guide audio analysis in audio data included in the content data, and information analysis associated with content in metadata included in the content data, and
the viewing and listening control module gives priority to viewing and listening environment control based on the viewing and listening environment control information generated by the information analysis associated with the content in the metadata.

9. The apparatus according to claim 1, wherein when the analysis module is allowed to generate viewing and listening environment control information by information analysis associated with content in metadata included in the content data, the viewing and listening control module controls the viewing and listening environment based on the viewing and listening environment control information generated by the information analysis associated with the content in the metadata, and
when the analysis module is not allowed to generate viewing and listening environment control information by information analysis associated with content in metadata included in the content data, the analysis module generates viewing and listening environment control information by at least one of text analysis in video data included in the content data and guide audio analysis in audio data included in the content data, and the viewing and listening control module controls the viewing and listening environment based on viewing and listening environment control information generated based on at least one of the video data and the audio data.

10. The apparatus according to claim 1, wherein when the analysis module is allowed to generate viewing and listening environment control information by information analysis associated with content in metadata included in the content data, the viewing and listening control module controls the viewing and listening environment based on the viewing and listening environment control information generated by the information analysis associated with the content in the metadata, and
when the analysis module is not allowed to generate viewing and listening environment control information by information analysis associated with content in metadata included in the content data, the analysis module generates viewing and listening environment control information by at least one of text analysis in video data included in the content data and guide audio analysis in audio data included in the content data, and the viewing and listening control module guides viewing and listening environment control content based on the generated viewing and listening environment control information and controls the viewing and listening environment based on the generated viewing and listening environment control information.
